(19) United States
(12) Patent Application Publication
(10) Pub. No.: US 2005/0163127 A1
(43) Pub. Date: Jul. 28, 2005

(54) Buffer switch and scheduling method thereof

(76) Inventors: Yeong Choi, Ansan-si (KR); Byung-Gu Choe, Seoul (KR); Sun-Gi Kim, Seoul (KR)

Correspondence Address: Robert E. Bushnell;Suite 300, 1522 K Street, N.W., Washington, DC, 20005-1202, US

(21) Appl. No.: 11/023,622

(22) Filed: Dec. 29, 2004

(30) Foreign Application Priority Data
Jan. 26, 2004 (KR) 2004-4843

(51) Int. Cl. H04L 12/28; H04L 12/54; H04L 12/56

(52) U.S. Cl. 370/395.4; 370/413; 370/428

(57) ABSTRACT

In a buffer switch and scheduling method thereof, conflict sensing and random selection logic configuration are not required. The buffer switch comprises: input buffer units for converting serial data inputted from respective input ports to parallel data; shift and comparison units for comparing currently stored data to parallel data aligned by the input buffer units, for determining paths to output the data depending on data validity, and for calculating a gating time needed to forward the data; output buffer units for outputting the data received via the input ports at the same speed as the speed at reception; a switching unit for gating paths between the shift and comparison units and the output buffer units; and a control unit for establishing the paths by enabling the input buffer units and the output buffer units for the gating time of relevant buffers depending on the establishment paths and the gating time from the shift and comparison unit.

### CLAIM OF PRIORITY

This application makes reference to, incorporates the same herein, and claims all benefits accruing under 35 U.S.C. § 119 from an application for BUFFER SWITCHAND SCHEDULING METHOD THEREOF earlier filed in the Korean Intellectual Property Office on 26 Jan. 2004 and there duly assigned Serial No. 2004-4843.

### BACKGROUND OF THE INVENTION

1. Technical Field

The present invention relates to a buffer switch and scheduling method thereof and, more particularly, to a buffer switch and scheduling method thereof in which conflict sensing and random selection logic configuration are not required.

2. Related Art

A number of studies have been made over past the decade for the purpose of providing a variety of services on an integrated service network.

In particular, many scheduling schemes have been suggested to guarantee a band and a delay to a user who subscribes to a service contract without occurrence of reduced flow which does not comply with the service contract.

For example, there is a work-conserving scheme that does not consume time when cells remain. The work-conserving scheme includes ‘virtual clock’, ‘delay-EDD (Earliest-Due-Date)’, ‘WFQ (Weighted Fair Queuing)’, ‘WF2Q (Worst-case Fair Weighted Fair Queuing)’, ‘SCFQ (Self-Clocked Fair Queuing)’, and the like.

In addition, there is also a non-work conserving scheme in which a cell time may just elapse idly in consideration of delay variations or the like when the cells remain. The non-work conserving scheme includes ‘jitter-EDD’, ‘stop-and-go’, ‘HRR (Hierarchical Round Robin)’, ‘RCSP (Rate-Controlled Static Priority)’, and the like.

Most of such studies have so far been conducted with respect to an output buffer switch.

Such an output buffer switch has many advantages in presenting QoS (Quality of Service), but it has limitations that memory speed must be fast and equal to the sum of all input speeds.

Limited memory speed is expected to be a factor in the occurrence of a bottleneck in total speed since the increasing rate of memory speed is lower than that of processor speed due to technical constraints.

On the other hand, in an input buffer switch, a memory speed much higher than that of one channel is not required. Accordingly, it is considered under current technical standards that the input buffer switch has excellent applicability as compared to the output buffer switch or shared buffer switch.

The input buffer switch, however, has a limitation in that throughput reaches only 58.6% for uniform input traffic due to HOL (Head-Of-Line) blocking.

However, this value is obtained only when the input buffer operates in a FIFO (First In First Out) scheme. It is known that the throughput can increase by 100% provided that the input buffer separately manages a queue for each output buffer in a virtual output queuing (VOQ) scheme. Accordingly, use of the input buffer switch has been increasing recently.

Most of such input buffer switches are crossbar switches with input buffers. An example of an input buffer switch includes ‘TT1/Enhanced TT1 switch’ available from PMC, ‘12000GSR’ and ‘50-Gb/s IP router’ available from CISCO Corporation, or the like.

In particular, the CISCO Corporation's ‘IP router’ performs internal cell switching and, hence, utilizes a scheme in which a packet with a variable length is divided into cells with a fixed length, the cells each pass through cell switches, and they are then reassembled and transmitted.

The crossbar switch has disadvantages in that the complexity of its implementation increases in proportion to N2 at an N-port crossbar, and control is more complex when guaranteeing QoS because conflicts must be solved at both input ports and output ports. On the other hand, the crossbar switch may be easily implemented with a very large-scale integrated circuit (VLSI) chip because of its simple structure, and it may operate at a high speed.

In the input buffer, conflict occurs. First, in an input buffer switch, including input buffers that manage queues in a VOQ scheme, conflict occurs at an input port of the switch when several VOQs want to send cells even though the number of the cells that can actually be inputted into one input port at one cell time is one. Second, even though cells have been inputted into a switch fabric, such as a crossbar, via input ports, it may be preferable that cells inputted via different input ports be outputted via the same output port. In this case, a conflict occurs.

To address the two conflicts, the input buffer switch sets a transmission order by using an arbitration algorithm upon transmission.

Such an arbitration algorithm includes ‘PIM (parallel iterative matching)’, ‘RRM (Round-Robin Matching)’, ‘iSLIP’, ‘i-LQF (iterative Longest Queue First)’, ‘i-OCF (iterative Oldest Cell First)‘, ‘FARR (Fair Arbitrated Round Robin)’, ‘FIRM (Fcfs In Round-robin Matching)’ and the like.

The PIM scheme includes a three-step operation composed of transmission request, transmission grant, and transmission acceptance. In the transmission request, N2 input queues send a transmission request to each output port. In the transmission grant step, each output port grants one of the received transmission requests based on probability, and notifies respective input ports of the result.

Meanwhile, since one input port may simultaneously receive several transmission grants from respective output ports, the input port accepts one of the received transmission grants based on probability at the transmission acceptance step.

As stated above, in the PIM scheme, repeating the three-step operation of the transmission request, grant and acceptance improves the performance of an algorithm. However, there is a problem in that high-speed operation is difficult since a probability function must be used at the transmission grant and acceptance steps.

It is in the SLIP scheme that the probability-dependent operation of the PIM is eliminated. This SLIP scheme is described in detail by N. McKweon et al. in the article “Scheduling Cells in an Input-Queued Switch” in Electronics Letters, Vol. 29, No. 25, December 1993.

The SLIP scheme uses round robin instead of the probability function at the transmission grant and transmission acceptance steps of the PIM scheme.

That is, the SLIP scheme uses a round-robin pointer instead of selecting one of several transmission requests or selecting one of several transmission grants based on probability.

If the current round-robin pointer value is i, the first input port following the i-th input port among the input ports that have sent a transmission request is granted.

In addition, the round-robin pointer value is incremented by 1 only when the transmission grant is accepted by the input port. The round-robin pointer is also used in the transmission acceptance operation of the input ports.

However, there is a problem with such a SLIP scheme in that a synchronization phenomenon, by which several output ports grant the same input port, arises.

To eliminate such a synchronization phenomenon, it is necessary to repeat the SLIP algorithm several times. In an N×N switch, the algorithm can be completely converged when it is repeated N times in the worst case.

Furthermore, in the SLIP algorithm, as the number of input/output ports increases, the number of transmission requests or grants, which must be retrieved at the transmission grant or acceptance step, increases. That is, there is a problem in that, as the number of input/output ports increases, a high speed operation becomes difficult.

A 2DRR algorithm is described in detail in the article “Two-dimensional Round-Robin Schedulers for Packet Switches with Multiple Input Queues” by R. O. LaMaire et al., IEEE/ACM Trans. Networking, Vol. 2., No. 5., October 1994, and in U.S. Pat. No. 5,299,190.

This 2DRR scheme retrieves a transmission request matrix, in which N2 transmission requests are represented by a two-dimensional N×N matrix, at the N-th step so as to identify a transmission request which will be forwarded. The 2DRR algorithm has the same service fairness as the process wherein the SLIP algorithm is executed N times.

In the article and the related patent, the basic 2DRR algorithm retrieves the transmission request matrix depending on a retrieving sequence defined in a pattern sequence matrix so as to identify a transmission request to be transmitted.

In the article and the related patent, an enhanced 2DRR algorithm exhibits improved fairness for a specific traffic pattern. It is difficult for the 2DRR algorithm to operate at high speed because the number of the steps needed to perform the algorithm also increases as the number N of the input and output ports increases.

Meanwhile, C. Lund et al. have proposed a method for enhancing service fairness by using time information upon controlling the contention at an input buffer switch in U.S. Pat. No. 5,517,495. In this invention, each inputport requests a communication contention control module to forward a cell that has waited the longest time based on the priority of each output port.

The contention control module identifies the cell that has waited the longest time among the cells, and notifies each input port of the result. Each input port may simultaneously receive the grants from several output ports. The input port accepts the cell waiting the longest time among the cells.

The above invention has performance superior to that of the PIM scheme or the SLIP scheme, whereas high speed operation is impossible since time information must be transmitted upon transmission grant and acceptance, and also a minimum value must be found from much time information per unit time.

The following patents are considered to be generally pertinent to the present invention, but are burdened by the disadvantages set forth above: U.S. Pat. No. 4,956,772 to Neches, entitled METHODS OF SELECTING SIMULTANEOUSLY TRANSMITTED MESSAGES IN A MULTIPROCESSOR SYSTEM, issued on Sep. 11, 1990; U.S. Pat. No. 4,945,471 to Neches, entitled MESSAGE TRANSMISSION SYSTEM FOR SELECTIVELY TRANSMITTING ONE OF TWO COLLIDING MESSAGES BASED ON CONTENTS THEREOF, issued on Jul. 31, 1990; U.S. Pat. No. 6,621,851 to Agee et al., entitled PRIORITY MESSAGE METHOD FOR A DISCRETE MULTITONE SPREAD SPECTRUM COMMUNICATIONS SYSTEM, issued on Sep. 16, 2003; U.S. Pat. No. 5,655,096 to Branigin, entitled METHOD AND APPARATUS FOR DYNAMIC SCHEDULING OF INSTRUCTIONS TO ENSURE SEQUENTIALLY COHERENT DATA IN A PROCESSOR EMPLOYING OUT-OF-ORDER EXECUTION, issued on Aug. 5, 1997; U.S. Pat. No. 5,276,899 to Neches, entitled MULTIPROCESSOR SORTING NETWORK FOR SORTING WHILE TRANSMITTING CONCURRENTLY PRESENTED MESSAGES BY MESSAGE CONTENT TO DELIVER A HIGHEST PRIORITY MESSAGE, issued on Jan. 4, 1994; and U.S. Pat. No. 5,006,978 to Neches, entitled RELATIONAL DATABASE SYSTEM HAVING A NETWORK FOR TRANSMITTING COLLIDING PACKETS AND A PLURALITY OF PROCESSORS EACH STORING A DISJOINT PORTION OF DATABASE, issued on Apr. 9,1991.

### SUMMARY OF THE INVENTION

The present invention has therefore been developed to solve the aforementioned problems, and it is an objective of the present invention to provide a buffer switch and scheduling method thereof in which the above-mentioned conflict sensing and random selection logic configuration are not required.

Furthermore, it is another objective of the present invention to provide a buffer switch and scheduling method thereof in which an increase in load on the operation is prevented by repeating the same cycle several times, and path control (such as priority setting), path gating limitation, or the like is possible upon path selection.

According to an aspect of the present invention, there is provided a buffer switch comprising: input buffer units for converting serial data inputted from respective input ports to parallel data; shift and comparison units for comparing currently stored data to the parallel data aligned by the input buffer units, for determining paths to output the data depending on data validity, and for calculating a gating time needed to forward the data; output buffer units for outputting the data received via the input ports at the same speed as that upon receiving; a switching unit for gating paths between the shift and comparison units and the output buffer units; and a control unit for establishing the paths by enabling the input buffer units and the output buffer units for the gating time of relevant buffers depending on the determined paths and the gating time from the shift and comparison unit.

Each of the input buffer units includes parallel buffers corresponding to the number of the output ports, and aligns and stores the serial data of a relevant input port as parallel data.

Each of the shift and comparison units compares the data inputted to the input buffer unit and its received data, and determines that the data is valid when the two data are the same, so as to establish a path to a destination output port, and to set a gating time based on the number of data.

The shift and comparison unit compares the data inputted to the input buffer unit and its received data, and recognizes that the data is shifting or in an abnormal state, so as to maintain the gating time for current paths when the two data are not the same.

The shift and comparison unit compares the data inputted to the input buffer unit and its received data, establishes a path to a destination output port, and sets a gating time based on the number of data when continuous data are repeatedly the same.

The switching unit is in the form of a full mesh or a wire bridge.

The control unit performs a path limiting function by determining whether the path is limited, and by allowing the limited path to be not enabled or disabled.

The control unit performs a priority function by setting a priority for each path, and by processing the path set by the shift and comparison unit depending on the priority.

The control unit determines the priority based on the input ports and/or the output ports so as to perform the priority function.

The control unit establishes a path for a port having no set priority in a round-robin scheme.

The control unit performs a bandwidth setting function by allocating a bandwidth to each port, and by permitting data corresponding to the allocated bandwidth and dropping subsequent input data.

According to another aspect of the present invention, there is provided a scheduling method of a buffer switch, including the steps of: converting, by means of a control module, serial data to parallel data by shifting data inputted to each input port to each parallel buffer in input buffer modules; comparing, by means of shift and comparison modules, currently stored data to the parallel data aligned by the input buffer modules, determining paths to output the data depending on data validity and calculating a gating time needed for data transmission; gating, by means of the control module, relevant paths for the time calculated in the gating time calculating step; and outputting, by means of output buffer modules, received data at the same speed as that at which the data is received by the input port.

The method further comprises step of meeting, by means of the control module, a limitation requirement for bandwidth allocation by dropping data exceeding allocated bandwidth when there is a limitation for bandwidth allocation.

The path determining and gating time calculating step includes the steps of: comparing, by means of the shift and comparison modules, currently stored data to the parallel data aligned by the input buffer modules so as to check data validity; determining that the data is valid when the two data are the same after comparing the data inputted to the input buffer module and the data received by the shift and comparison module at the checking step; and establishing paths to destination output ports and setting a gating time based on the number of the data.

The path determining and gating time calculating step includes the sub-steps of: comparing, by means of the shift and comparison modules, currently stored data to the parallel data aligned by the input buffer modules to check data validity; and recognizing that the data is shifting or in an abnormal state, and maintaining the gating time for current paths when the two data are not the same after comparing the data inputted to the input buffer module and the data received by the shift and comparison modules at the checking step.

The path determining and gating time calculating step includes the sub-steps of: comparing, by means of the shift and comparison modules, currently stored data to the parallel data aligned by the input buffer modules so as to check data validity; and establishing the paths to destination output ports and setting a gating time based on the number of the data when continuous data are repeatedly the same after comparing the data inputted to the input buffer module and the data received by the shift and comparison modules at the checking step.

The method further comprises, after the path establishment step, the step of assigning, by means of the control module, a priority to the data based on a priority determination table, wherein the control module establishes the paths depending on the priority assigned at the gating time step according to the path gating determination, and the control module maintains the path establishment for a path establishment maintenance time.

The control module further comprises, after the path determination step, the step of determining, by means of the control module, whether there is a path establishment limitation, and disabling path establishment when the path has the path establishment limitation.

### BRIEF DESCRIPTION OF THE DRAWINGS

The above and other features and advantages of the present invention will become more apparent to those of ordinary skill in the art by describing detailed preferred embodiments thereof with reference to the attached drawings, in which:

FIG. 1 is a diagram illustrating the operation of a typical 4×4 switch;

FIGS. 2A to 2D are diagrams illustrating a path establishment process in a typical 4×4 switch;

FIG. 3 is a diagram for a 4×4 input buffer switch according to an embodiment of the present invention;

FIG. 4 is a diagram for explaining a process of converting serial data to parallel data according to the present invention;

FIGS. 5A to 5C are diagrams for explaining a path establishment and set time determination process of the present invention;

FIG. 6 is a diagram for explaining a connection process of a full meshed type applied to a switch module of the present invention;

FIG. 7 is a diagram for explaining a connection process of a wire bridge type applied to a switch module of the present invention;

FIG. 8 is a diagram for explaining path establishment, path limitation, and priority setting process controlled by a control module of the present invention;

FIG. 9 is a diagram for explaining a bandwidth setting process controlled by a control module of the present invention; and

FIG. 10 is a flow chart for a scheduling method of an n*n switch according to an embodiment of the present invention.

### DETAILED DESCRIPTION OF THE INVENTION

Hereinafter, preferred embodiments of the present invention will be described in detail with reference to the accompanying drawings so that those skilled in the art to which the present invention belongs can easily practice the present invention.

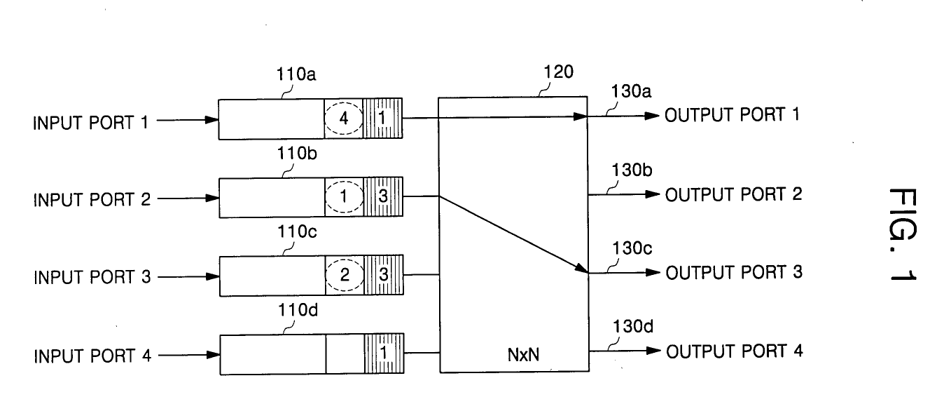

FIG. 1 illustrates the operation of a typical 4×4 switch, in which data inputted into respective input ports 110a to 110d include a destination port number or destination port numbers.

In FIG. 1, reference time data inputted into the input port 1 110a has a destination port number of 1, reference time data inputted into the input port 2 110b has a destination port number of 3, reference time data inputted into the input port 3 110c has a destination port number of 3, and reference time data inputted into the input port 4 110d has a destination port number of 1.

At this time, a parallel iterative matching (PIM) scheme, which is a typical scheme of a path establishment algorithm is used. Since different input ports 2 110b and 3 110c want to output to the same destination 3 at a reference time, but two data cannot simultaneously pass through the output port 3 130c, blocking results and normal flow cannot be maintained.

There is a need for a scheduling algorithm which, by solving such a blocking problem, determines data to be sent following data to be first sent, and determines paths between the input ports 110a to 110d and the output ports 130a to 130d to send the data.

To determine the path and solve the blocking problem, transmission request, grant, and acceptance cycles between the respective input ports 110a to 110d and the respective output ports 130a to 130d must be repeated for all paths.

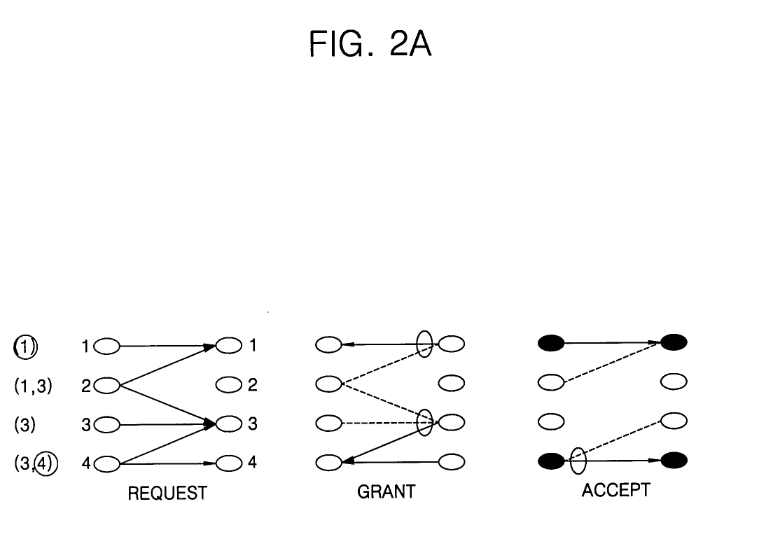

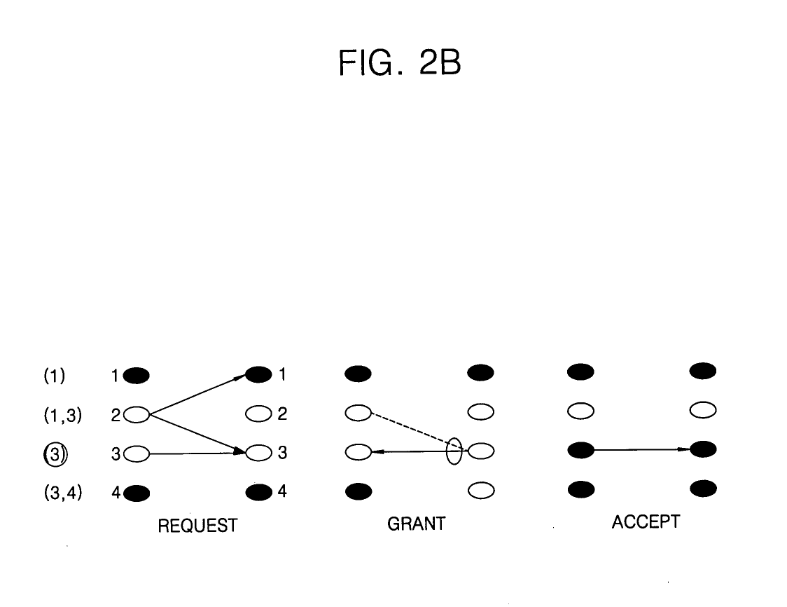

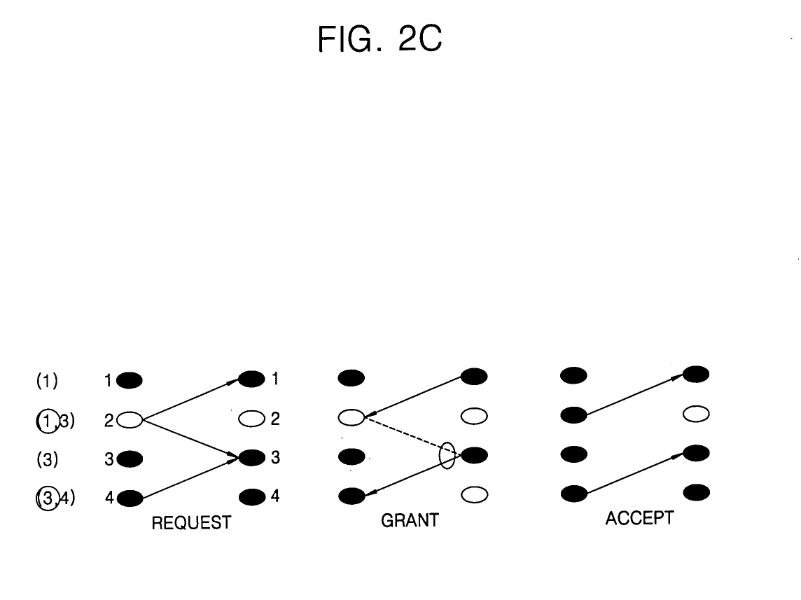

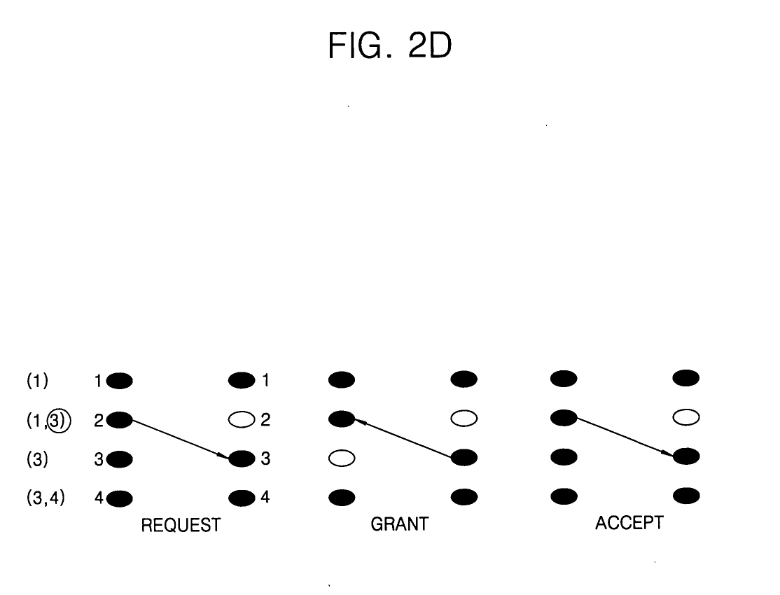

FIGS. 2A to 2D are diagrams illustrating a path establishment process in a typical 4×4 switch.

FIG. 2A is a diagram for explaining a process of selecting output ports 1 and 4. There are data with a destination port number of 1 at an input port 1, data with destination port numbers of 1 and 3 at an input port 2, data with a destination port number of 3 at an input port 3, and data with destination port numbers of 3 and 4 at an input port 4.

When it is a reference time, all of the input ports having data to be sent issue a transmission request signal. In FIG. 2A, the input port 1 issues the transmission request signal to the output port 1, the input port 2 issues the transmission request signal to the output ports 1 and 3, the input port 3 issues the transmission request signal to the output port 3, and the input port 4 issues the transmission request signal to the output ports 3 and 4.

The output port 1 selects either the input port 1 or the input port 2, and returns a transmission grant signal. In FIG. 2A, the output port 1 returns the transmission grant signal to the input port 1, the output port 3 returns the transmission grant signal to the input port 4, and the output port 4 returns the transmission grant signal to the input port 4.

Accordingly, the input port 4 receives the transmission grant signals from the output port 3 and the output port 4 at the same time. The input port 4 then selects one of the two transmission grant signals arriving at the same time, and forwards a transmission accept signal. In FIG. 2A, the input port 4 selects the output port 4 to which the transmission accept signal is forwarded.

FIG. 2B is a diagram for explaining a process of selecting the output port 3. The input port 2 transmits a transmission request signal to the output ports 1 and 3, and the input port 3 also transmits the transmission request signal to the output port 3.

Then, the output ports 1 and 3 return a transmission grant signal. FIG. 2B shows that the output port 3 transmits the transmission grant signal to the input port 3. The input port 3 then transmits a transmission accept signal to the output port 3.

FIG. 2C is a diagram for explaining a process of selecting the output ports 1 and 3. The input port 2 sends a transmission request signal to the output ports 1 and 3, and the input port 4 sends the transmission request signal to the output port 3.

The output port 1 then sends a transmission grant signal to the input port 2, and the output port 3 sends the transmission grant signal to the input port 4 from the input port 2 and the input port 4 that have transmitted the transmission request signals arriving simultaneously.

In addition, the input port 2 sends a transmission accept signal to the output port 1 and the input port 4 sends the transmission accept signal to the output port 3.

Finally, FIG. 2D is a diagram illustrating a process of selecting the output port 3. The input port 2, having data that will be sent, sends a transmission request signal to the output port 3.

Then, the output port 3 returns a transmission grant signal to the input port 2, and the input port 2 in turn sends a transmission accept signal to the output port 3.

FIGS. 2A to 2D show the four steps for the process of establishing paths between the input ports and the output ports in the 4×4 switch. The path is established based on a principle that the respective paths between the input ports and the output ports are linked by repeating a conflict sensing and random selection process of an output port/input port arbiter. A path connection cycle is completed by performing three processes of transmission request, transmission grant, and transmission accept. When the port path is unfortunately selected one by one, 4 (time slots)×4 (ports)×3 (cycles) are required to connect four data paths, and a maximum of 48 repetitions of the operation is inconveniently required.

Consequently, in establishing the paths between the input ports and the output ports according to the conventional PIM manner, the following problems arise:
1. Conflict sensing and random selection logic are needed for an input port/output port arbiter.
2. Transmission request, grant, and acceptance cycles must be repeated until the connection of all paths is completed.
3. The control of path establishment, such as priority setting, path connection limitation or the like, is impossible since random logic is used to select the paths.

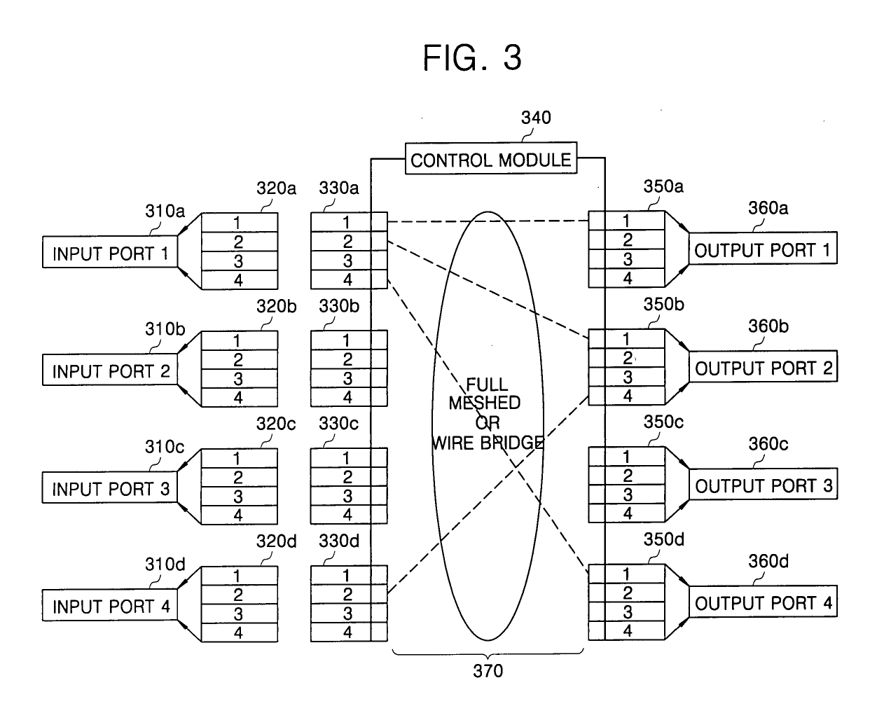

FIG. 3 shows a 4×4 input buffer switch according to an embodiment of the present invention.

Referring to FIG. 3, the switch includes four input buffer modules 320a to 320d, four shift and comparison modules 330a to 330d, a switch module 370 configured as a full mesh or wire bridge type, a control module 340, and four output buffer modules 350a to 350d.

Input ports include four input ports 310a to 310d, and the input ports 310a to 310d are connected to the input buffer modules 320a to 320d, respectively. Each of the input buffer modules 320a to 320d includes parallel buffers that correspond in number to output ports 360a to 360d. That is, each of the input buffer modules 320a to 320d includes four parallel buffers corresponding to the four output ports 360a to 360d.

In addition, each of the four parallel buffers, included in each of the input buffer modules 320a to 320d, is composed of four serial buffers.

The parallel buffers, included in each of the input buffer modules 320a to 320d as described above, convert the serial data received from the input ports 310a to 310d, respectively, to parallel data.

Each of the shift and comparison modules 330a to 330d includes four parallel shift and comparison buffers that correspond to the four parallel buffers included in each of the input buffer modules 320a to 320d. The shift and comparison modules compare the aligned parallel data, determine input and output paths for connection, and determine a path gating time.

The control module 340 is connected to the shift and comparison modules 330a to 330d and to the output buffer modules 350a to 350d so as to perform buffer control, path establishment, bandwidth setting limitations, and path connection setting limitations.

Hereinafter, the operation of preferred embodiments of the present invention will be described in detail.

First, the input ports 310a to 310d serially receive data, including a destination port number or destination port numbers.

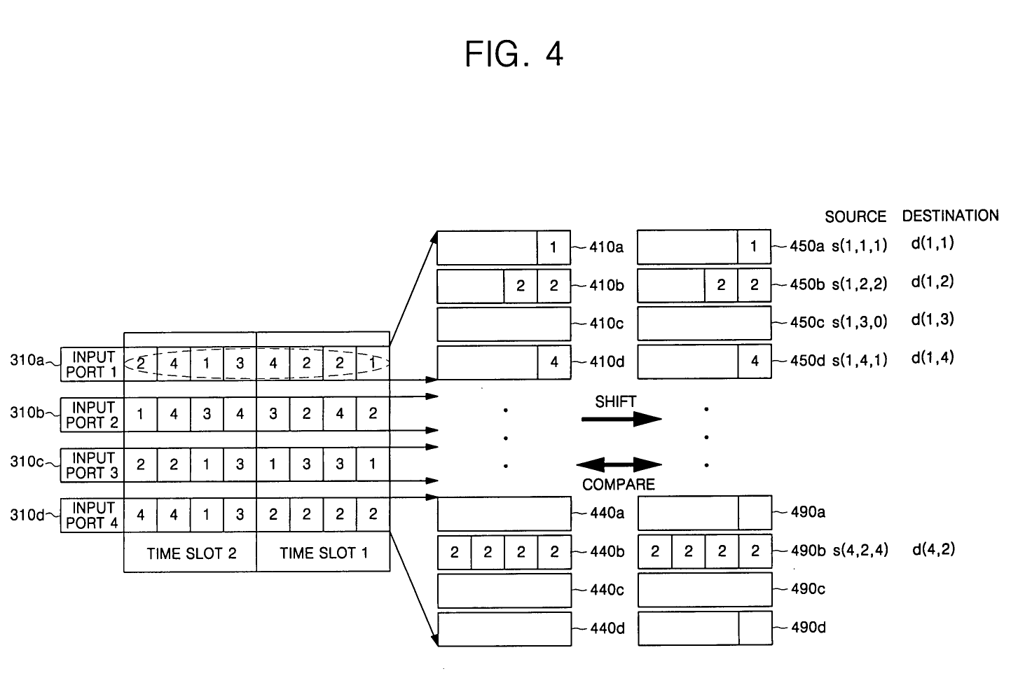

Referring to FIG. 4 for explaining the process of converting the serial data to parallel data according to the present invention, the input port 1 310a is a first-in-first-out (FIFO) buffer, and receives data with destination address numbers of 1, 2, 2, 4, 3, 1, 4 and 2. And, the input port 2 310b is also a FIFO buffer, and receives data with destination address numbers of 2, 4, 2, 3, 4, 3, 4 and 1.

The input port 3 310c is a FIFO buffer, and receives data with destination address numbers of 1, 3, 3, 1, 3, 1, 2 and 2, and the input port 4 310d is also a FIFO buffer, and receives data with destination address numbers of 2, 2, 2, 2, 3, 1, 4 and 4.

Generally, the number of input and output buffers needed for an n*n switch is “n”, in which the number of reference time slots to be handled as groups is also equal to the number “n”.

That is, the number of input and output buffers is determined based on a switch configuration, and is equal to “n.”

For example, in the case of a switch having a 4*4 configuration, four data are grouped and handled in one time slot. In the case of a 256*256 switch, 256 data are grouped and handled in one time slot. In this case, the number of input/output port buffers needed per each input port is also equal to the number “n”.

In FIG. 4, a reference time slot is a time during which the input data in “four” input port buffers can be processed. In the case of the input port 1 (310a), the input port 1 shifts “four” input data to respective parallel buffers 410a to 410d of the input buffer module during the reference time slot.

In other words, the input port 1 (310a) shifts data with a destination address of 1 to the first parallel buffer 410a of the parallel buffers 410a to 410d in the input buffer module. In addition, the input port 1 (310a) shifts two data with a destination address of 2 to the second parallel buffer 410b of the parallel buffers 410a to 410d in the input buffer module. Furthermore, the input port 1 (310a) shifts data with a destination address of 4 to the fourth parallel buffer 410d of the parallel buffers 410a to 41d in the input buffer module.

Meanwhile, the input port4 310d shifts four data with a destination address of 2 into the second parallel buffer 440b of the parallel buffers 440a to 440d in the input buffer module.

As stated above, the serial data inputted from the respective input ports 310a to 310d is converted to parallel data in the input buffer module. The input buffer module has unique areas corresponding to the output ports according to respective areas, and stores data in the areas corresponding to a destination address number of the input data according to this classification.

As a result of the storing, one datum is stored in the first parallel buffer 410a of the first input buffer in the input buffer module, two data are stored in the second parallel buffer 410b, and one datum is stored in the fourth parallel buffer 410d.

In addition, four data are stored in the second parallel buffer 440b of the fourth input buffer in the input buffer module. At this point, the number of data must be counted because it will become a path gating time later.

Next, in order to verify the validity of data in a relevant time slot, the shift and comparison modules 450a to 490d shift the data, and then verify the validity of the relevant data.

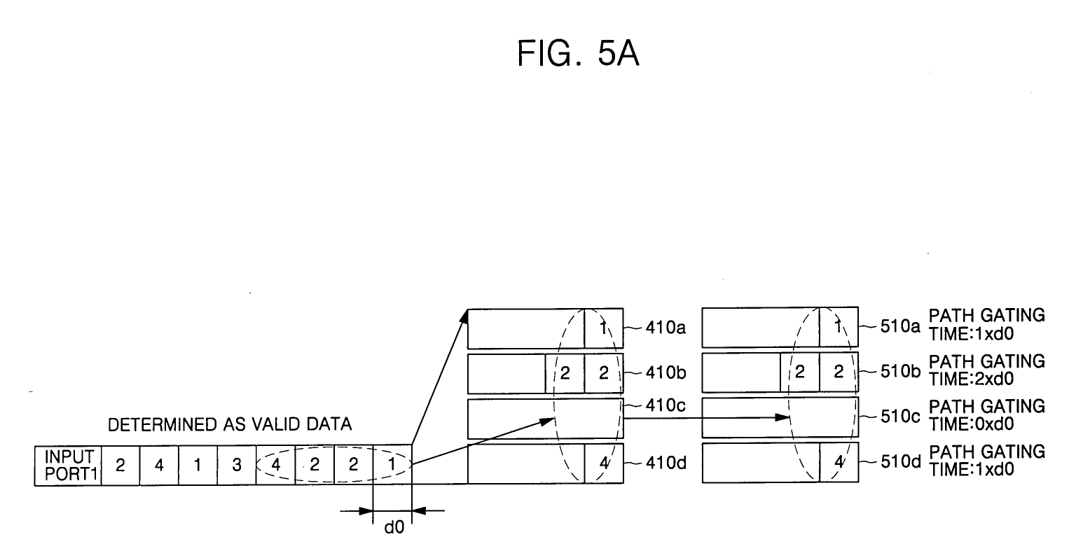

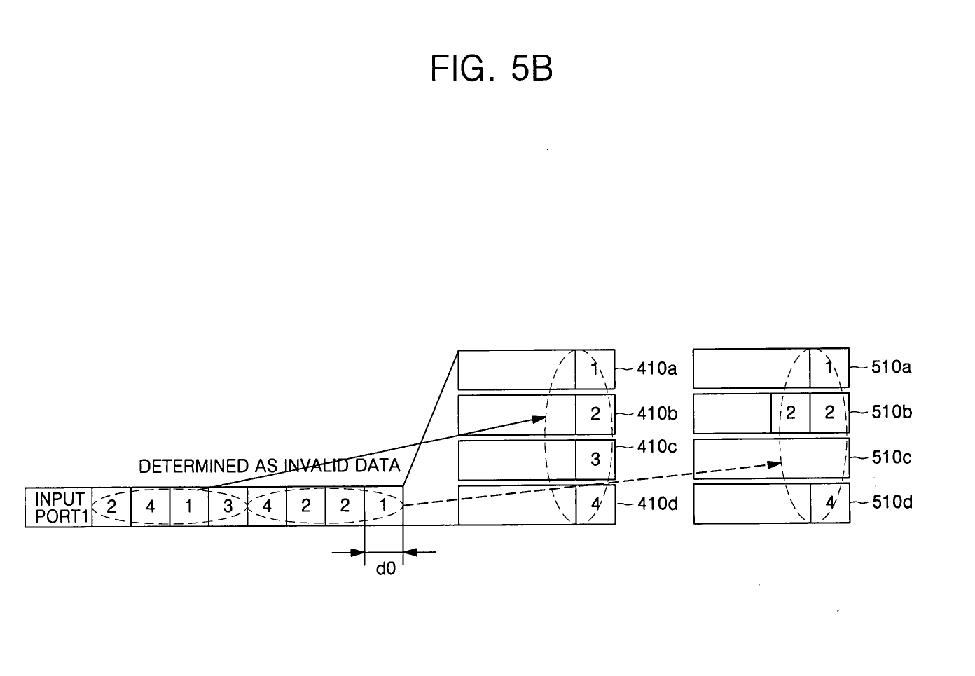

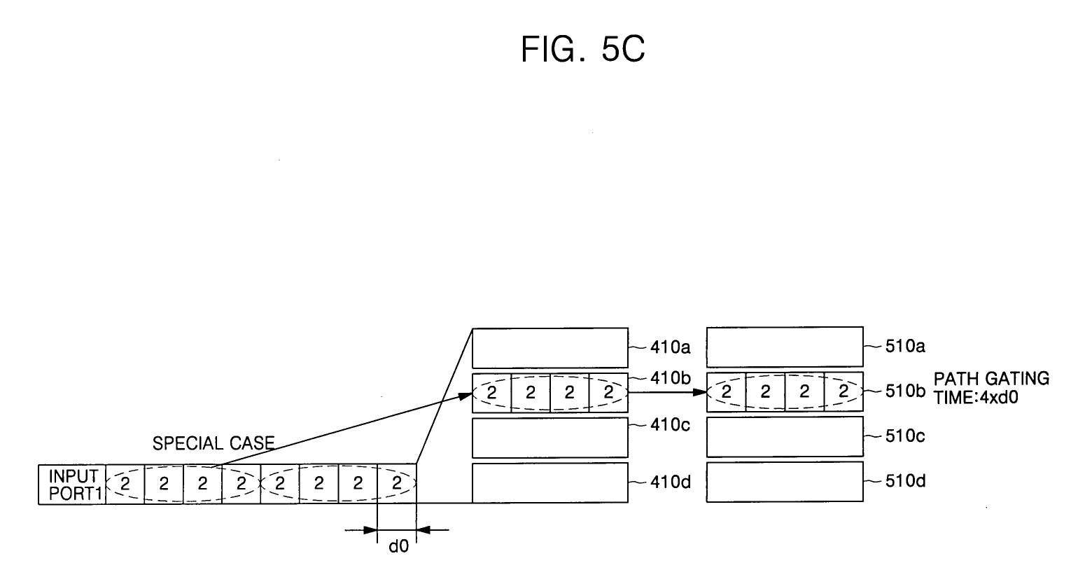

Referring to FIGS. 5A to 5C, the shift and comparison modules 510a to 510d compare the shifted and stored data to the aligned parallel data in the input buffer module 410a to 410d to verify the validity of the data.

As shown in FIG. 5A, the shift and comparison modules 510a to 510d compare the data inputted to the input buffer modules 410a to 410d to the received data, determine the data to be valid when the two data are the same, establish a path to the destination output port, and set a path gating time so that the connection is made based on the number of data.

As shown in FIG. 5B, the shift and comparison modules 510a to 510d compare the data inputted to the input buffer modules 410a to 410d to the received data, determine the data to be invalid when the two data are not the same, recognize that the data is shifting or in an abnormal state, and maintain a gating time to the path that is now under way.

In addition, as shown in FIG. 5C, the shift and comparison modules 510a to 510d compare the data inputted to the input buffer modules 410a to 410d to the received data, establish a path to the destination output port, and set a gating time based on the number of data when continuous data are repeatedly the same, which is a special case where continuous data are inputted.

Since the subsequently inputted datahave the same continuous value at this time as well, discrimination may not be made with regard to which one of the shift and comparison operation and the path establishment time maintaining operation takes priority. However, since it is only a phenomenon caused accidentally by the same data (which is actually a course in which next data are shifted to the input buffer), path establishment time maintenance must be given priority (i.e., the path maintenance is given priority over the shift and comparison result in the path establishment maintenance time).

Meanwhile, aprocess ofgatingbetween the input ports 310a to 310d and the output ports 360a to 360d based on the above-stated set information may be of the full meshed type or the wire bridge type.

For convenience of illustration, when s (x, y, z) is used in connection with the x-th parallel buffer in the shift and comparison modules 330a to 330d, it should be appreciated that the data at the input port “x” is outputted to the output port “y”, and a path establishment time is maintained for “z* reference time.”

For example, s (4, 3, 3) indicates that the data inputted into the input port 4 (310d) is connected to the output port 3 (360c), and implies that a path is maintained for 3 reference times.

Furthermore, for the parallel buffers in the output buffer modules 350a to 350d, d (x, y) indicates that the data inputted into the input port y is inputted to the output port x.

For respective ports, s (x, y, z) and d (x, y) have meanings as summarized in the following Table 1:

TABLE 1

| | | Meaning | Note |
|---|---|---|---|
| s | x | Starting input port number | Source |
| | y | Destination output port number | Destination |
| | z | Input/output port path establishment time | z*reference time |
| d | x | Receiving output port number | To |
| | y | Receiving input port number | From |

Details for respective connection processes will be hereinafter discussed.

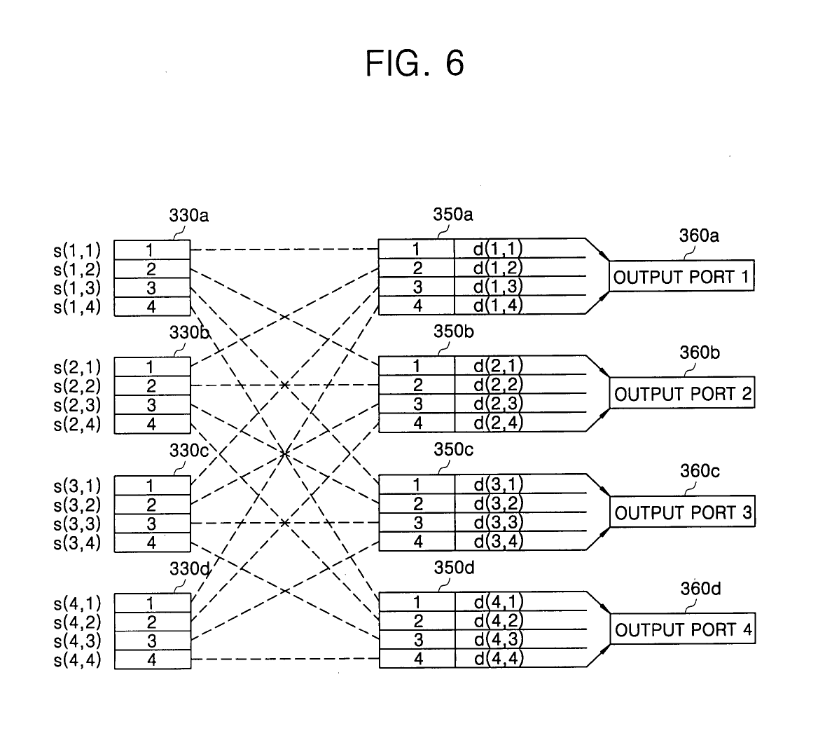

FIG. 6 is a diagram for explaining a process for a full meshed connection applied to a switch module of the present invention.

In the full meshed connection, the connection of the respective ports is made by gating paths between the input ports and the output ports by setting x and y, each of which indicates a source and a destination in s (x, y), to y and x values of d, respectively. That is, the first parallel buffer in the first shift and comparison buffer 330a of the shift and comparison modules 330a to 330d will have s (1, 1), which means that the data incoming from the input portI must be outputted to the output port 1, and thus the first parallel buffer is connected to the first parallel buffer in the first output buffer 350a of the output buffer modules 350a to 350d.

In addition, the second parallel buffer in the first shift and comparison buffer 330a will have s (1, 2). This means that the data incoming from the input port1 must be outputted to the output port 2, and thus the second parallel buffer is connected to the first parallel buffer in the second output buffer 350b of the output buffer modules 350a to 350d.

The overlapped number of each data confirmed by the shift and comparison modules 330a to 330d is inputted into a z digit of the s ( ) so that the data path is maintained for the path establishment time (z*reference time) of the input/output ports. The data arriving at the output buffer modules 350a to 350d are converted from parallel data to serial data, and are then finally outputted according to an output port speed rate.

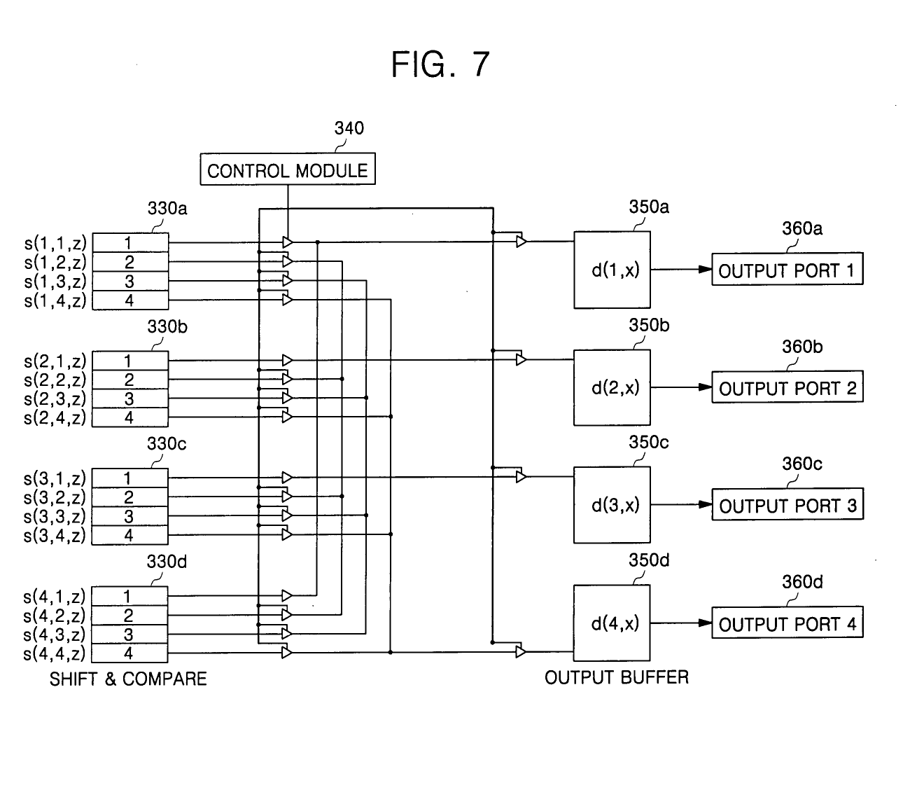

FIG. 7 is a diagram for explaining a process for a wire bridge connection type applied to the switch module of the present invention.

Since, in the wire bridge (and in contrast to the full meshed type), a connection path is used in common, the input/output ports will be controlled using a tri-buffer as shown in FIG. 7. An example of the connection is as shown in FIG. 7. For each port, the meanings of s(x, y, z) and d(x, y) are the same as those in the full meshed case.

A difference between the wire bridge and the full mesh resides in the fact that the separate buffers 350a to 350d for the output port are not used to accommodate the respective input ports, but a single buffer is used, and accordingly the parallel data is finally outputted in a direct manner according to the output port speed rate without being converted to the serial data when outputted to the output port.

For example, s (3, 3, 3) means that a data path is connected from the input port 3 to the output port 3 for “3*reference time”.

Meanwhile, the control module 340 will carry out buffer control, path establishment, bandwidth determination, priority setting, path connection limitation, and the like.

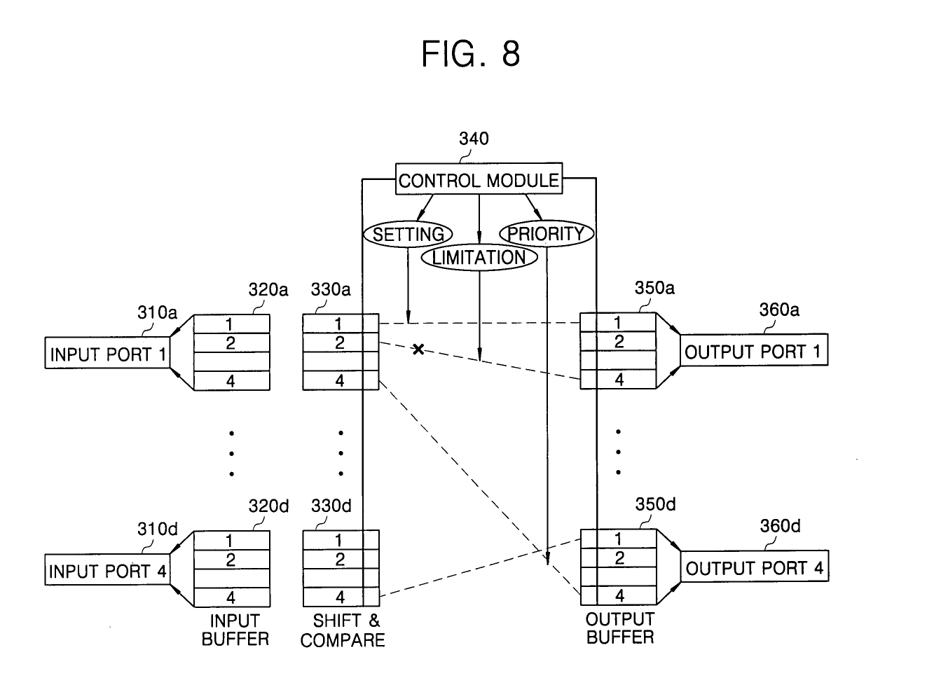

FIG. 8 is a diagram for explaining the operation of the control module shown in FIG. 3. Referring to the figure, the control module 340 performs path establishment by simultaneously enabling parallel buffers in a relevant shift and comparison buffer of relevant shift and comparison modules 330a to 330d and parallel buffers in a relevant output buffer of the output buffer modules 350a to 350d in the crossbar/wire bridge.

For example, FIG. 8 shows that the control module establishes the path by enabling the first parallel buffer in the first shift and comparison buffer 330a of the shift and comparison modules 330a to 330d, and the first parallel buffer in the first output buffer 350a of the output buffer modules 350a to 350d.

In addition, when a path is limited, the control module 340 does not enable the limited path even though the shift and comparison modules 330a to 330d have confirmed the connection path.

Furthermore, when the priority of each path is necessary, the control module 340 handles the path that has been confirmed by the shift and comparison modules 330a to 330d based on the priority.

In other words, when conflict occurs upon establishing a path, the control module 340 confirms the priority of the path, and establishes the path based on the priority. Table 2 is a priority setting table.

TABLE 2

| Set | Set port | | |
|---|---|---|---|
| priority | Source port | Output port | Note |
| 1 | s (1,2,3) | | Valid only when z = 1 |
| 2 | | d (4,1) | Valid only when z = 1 |
| 3 | | d (2.2) | Valid only when z = 1 |
| 4 | s (3,2,1) | | Valid only when z = 1 |
| — | | | |
| — | | | |

As can be seen from Table 2, the priority can be set at the output port as well as at the source port, and also can be limited depending on the number z. From Table 2, it can also be seen that the first priority is set when the source port is 1, the output port is 2, and at the same time that z is 1 or more, and the second priority is set when the output port is 4 and the input port is 1.

In addition, it can be seen that the third priority is set when the output port is 2, the input port is 2, and z is 1 or more, and the fourth priority is set when the source port is 3, the output port is 2, and z is 1 or more.

The control module 340 determines the existence and absence of priority data, and excludes the port from the priority when z=0. In addition, when a port does not have priority, the control module 340 sets the priority of the port based on a defined type (a round-robin type, or the like) so as to establish the path.

Table 3 is a table showing the result of priorities set by the control module 340 based on Table 2.

TABLE 3

| Port No. | z = ? | Actual priority | Note |
|---|---|---|---|
| s (1,2,?) | 0 | | No data to be sent |
| d (4,1) | 2 | 1 | |
| d (2,2) | 1 | 2 | |
| s (3,2,?) | 3 | 3 | |
| s (1,1,?) | 2 | No sequence | |
| s (4,3,?) | 1 | No sequence | |

As seen from Table 3, z=0 when s (1,2), namely, when the input port is 1 and the output port is 2, and it is not necessary to assign a priority since there is no data to be sent.

The first priority is set since z=2 when d (4, 1), namely, when the output port is 4 and the input port is 1. The second priority is set since z=1 when d (2,2), namely, when the output port is 2 and the input port is 2. The third priority is set since z=3 when s (3, 2, 3), namely, when the input port is 3 and the output port is 2. In the case of the remaining s (1, 1, 2) and d (4, 3), respective priorities are set by round robin or the like.

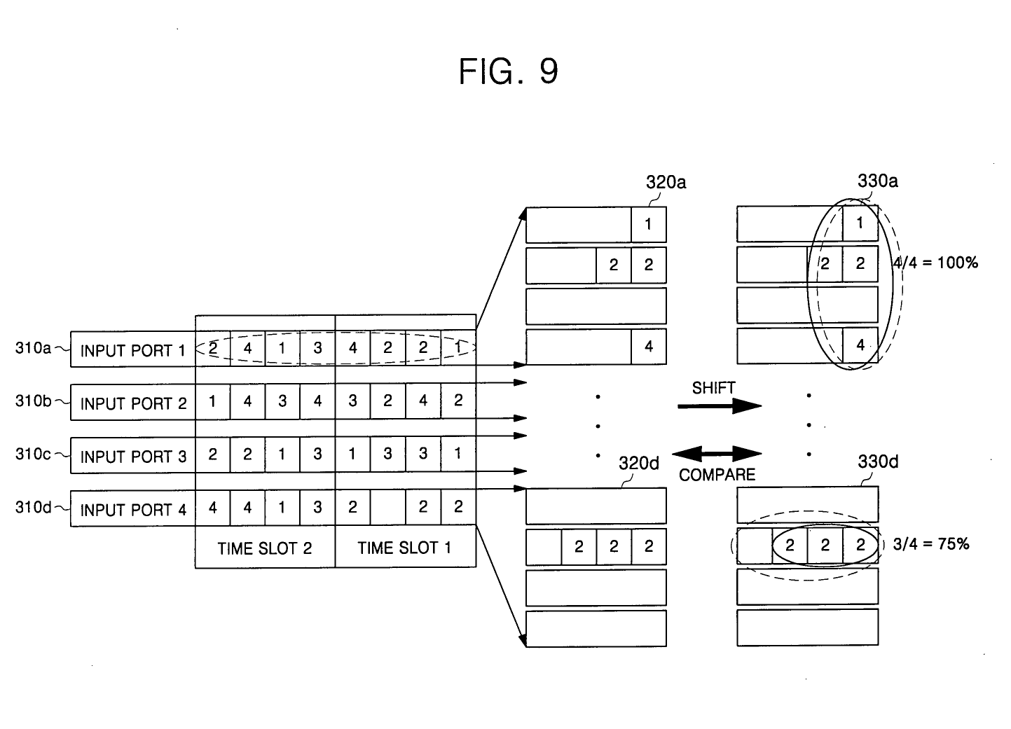

Meanwhile, the control module 340 has a bandwidth setting function. FIG. 9 is a diagram for explaining the bandwidth setting function of the control module shown in FIG. 3.

Referring to FIG. 9, in the input port 1 310a, each of the compared data occupies one-quarter when n=4, which means a bandwidth of 25%.

At this point, when the capacity of the input port 1 310a is limited to 50%, two digits of the data are permitted, and subsequently inputted data are dropped, which makes it possible to limit the input to 50%.

Generally, one data means 1/n % in an n*n configuration. When up to A% was allowed, necessary data (allowable data D) is represented by the following equation:
D=(100/n)*x (Equation 1)

FIG. 9 shows that the first shift and comparison buffer 330a of the shift and comparison modules 330a to 330d has accepted four data within an allowable bandwidth of 100%. It is shown that the fourth shift and comparison module 330d has accepted three valid data within the allowable bandwidth of 100% and, accordingly, actually used bandwidth is 75%.

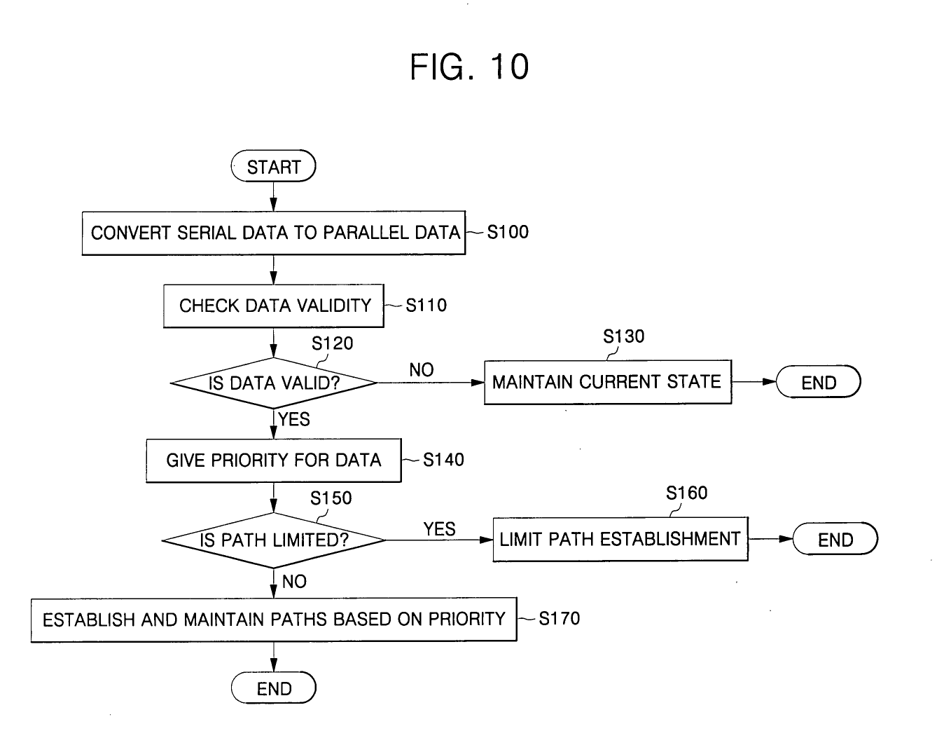

FIG. 10 is a flow chart of a scheduling method for an n*n switch according to an embodiment of the present invention.

Referring to FIG. 10, the control module 340 first converts the serial data to parallel data by shifting the data inputted to the respective input ports to the respective parallel buffers in the input buffer module (S100).

At this point, when there is a limitation on bandwidth allocation, the control module 340 meets the requirement to limit bandwidth allocation by dropping data deviating from the allocated bandwidth.

In addition, the shift and comparison module 330a to 330d checks the validity of the parallel data while shifting the parallel data (S110). Since the data should be forwarded from the input port to the output port when the data is valid, the control module 340 enables the path establishment process and the path maintenance process to be initiated.

That is, the control module 340 assigns priority for the data based on the priority determination table (S140), establishes a path depending on the given priority, and maintains the established path for a path establishment maintenance time (S170).

At this point, the control module 340 determines whether there is a limitation on path establishment. When there is a limitation on path establishment, the control module 340 does not establish the path (S160).

Meanwhile, when the shift and comparison module 330a to 330d has checked that the data is invalid data or special data, the control module 340 does not shift the data but initiates the current path establishment and path maintaining processes (S170).

According to the present invention as described above, it is possible to connect the inputted data to output ports by directly checking the destination of the inputted data without performing inquiry, response, and acquisition processes, which is in contrast to the scheduling method of the conventional PIM manner for gating all paths by repeating a conflict sensing and random selection process several times through processes, such as transmission request, transmission grant, and transmission accept, so as to improve data delivery.

In addition, according to the present invention, it is possible to control path establishment, such as priority setting or a path connection limitation, since the paths are not selected in a random in a manner distinguishable from the prior art

Furthermore, according to the present invention, an interconnection relationship between the input ports and the output ports is simplified as s(x, y, z)⇄d (y, x), and thus the scheduling method is simply and easily implemented.

Moreover, according to the present invention, it is possible to selectively apply either a full mesh type or a wire bridge type, depending on the type of switch to be implemented.

Finally, according to the present invention, it is possible to guarantee maximum data transmission since the number and capacity of the input/output buffers is set to conform to a switch configuration (n*n).

Although the preferred embodiments of the present invention have been described in detail, it will be appreciated by those skilled in the art to which the present invention pertains that several modifications and variations can be made without departing from the spirit and scope of the present invention as defined in the appended claims. Accordingly, future variations of the embodiments of the present invention can be covered by the technique of the present invention.

1. A buffer switch, comprising:
input buffer units for converting serial data inputted from respective input ports to parallel data;
shift and comparison units for comparing currently stored data to the parallel data, for determining paths for output of data depending on data validity, and for calculating a gating time needed to forward the data;
output buffer units for outputting the data received via the input ports at a speed identical to a reception speed;
a switching unit for gating paths between the shift and comparison units and the output buffer units; and
a control unit for establishing the paths by enabling the input buffer units and the output buffer units for the gating time of relevant buffers depending on the determined paths and the calculated gating time from the shift and comparison units.

2. The buffer switch according to claim 1, wherein each of the input buffer units includes parallel buffers corresponding to the number of the output ports, and aligns and stores the serial data of a relevant input port as the parallel data.

3. The buffer switch according to claim 1, wherein each of the shift and comparison units compares the data inputted to the input buffer unit and received data of the shift and comparison units, and determines that the data is valid when the data inputted to the input buffer unit and the received data of the shift and comparison units are the same so as to establish a path to a destination output port and to set a gating time based on the number of the data.

4. The buffer switch according to claim 1, wherein each of the shift and comparison units compares the data inputted to the input buffer unit and the received data, and recognizes that the data is shifting so as to maintain the gating time for current paths when the data inputted to the input buffer unit and the received data are not the same.

5. The buffer switch according to claim 1, wherein each of the shift and comparison units compares the data inputted to the input buffer unit and the received data, and recognizes that the data is in an abnormal state so as to maintain the gating time for current paths when the data inputted to the input buffer unit and the received data are not the same.

6. The buffer switch according to claim 1, wherein each of the shift and comparison units compares the data inputted to the input buffer unit and the received data, and establishes a path to a destination output port and sets a gating time based on number of the data when the data inputted to the input buffer unit and the received data are repeatedly and continuously the same.

7. The buffer switch according to claim 1, wherein the control unit performs a path limiting function by determining whether the path is limited and causing the limited path to be not enabled.

8. The buffer switch according to claim 1, wherein the control unit performs a priority function by setting a priority of each path between the shift and comparison units and the output buffer units, and by processing the paths determined by the shift and comparison units depending on the set priority.

9. The buffer switch according to claim 8, wherein the control unit performs the priority function by determining the priority based on the input ports.

10. The buffer switch according to claim 8, wherein the control unit performs the priority function by determining the priority based on the output ports.

11. The buffer switch according to claim 8, wherein the control unit performs the priority function by determining the priority based on the input parts and the output ports.

12. The buffer switch according to claim 1, wherein the control unit performs a bandwidth setting function by allocating a bandwidth to each of the ports, and by permitting data corresponding to the allocated bandwidth and dropping subsequent input data.

13. A scheduling method of a buffer switch, comprising the steps of:
(a) converting, by means of a control module, serial data to parallel data by shifting data inputted to an input port to a parallel buffer in an input buffer module;
(b) comparing, by means of shift and comparison modules, currently stored data to the parallel data;
(c) determining paths for output of data depending on data validity, and calculating a gating time needed for data transmission;
(d) gating, by means of the control module, relevant paths for the calculated gating time; and
(e) outputting, by means of an output buffer module, received data at a speed identical to a reception speed.

14. The scheduling method according to claim 13, further comprising the step of:
meeting, bymeans of the control module, a limitation requirement for bandwidth allocation by dropping data exceeding an allocated bandwidth when there is a limitation for the bandwidth allocation.

15. The scheduling method according to claim 13, wherein step (c) comprises sub-steps of:
comparing the data inputted to the input buffer module and the data received by the shift and comparison module;
determining that the data is valid when the data inputted to the input buffer module and the data received by the shift and comparison module are the same; and
establishing paths to destination output ports and setting a gating time based on a number of the data.

16. The scheduling method according to claim 13, wherein step (c) comprises sub-steps of:
comparing the data inputted to the input buffer module and the data received by the shift and comparison module; and
recognizing that the data is shifting and maintaining the gating time for current paths when the data inputted to the input buffer module and the data received by the shift and comparison module are not the same.

17. The scheduling method according to claim 13, wherein step (c) comprises sub-steps of:
comparing the data inputted to the input buffer module and the data received by the shift and comparison module; and
recognizing that the data is in an abnormal state and maintaining the gating time for current paths when the data inputted to the input buffer module and the data received by the shift and comparison module are not the same.

18. The scheduling method according to claim 13, wherein step (c) comprises sub-steps of:
comparing the data inputted to the input buffer module and the data received by the shift and comparison module; and
establishing paths to destination output ports and setting a gating time based on a number of the data when the data inputted to the input buffer module and the data received by the shift and comparison module are continuously and repeatedly the same.

19. The scheduling method according to claim 13, further comprising, after determining the path in step (c), the step of:
assigning, by means of the control module, a priority for the data based on a priority determination table, wherein the control module establishes the paths depending on the assigned priority according to the determined path, and maintains path establishment for a path establishment maintenance time.

20. The scheduling method according to claim 13, further comprising, after determining the path in step (c), the step of:
determining, by means of the control module, whether there is a path establishment limitation and disabling path establishment when there is the path establishment limitation.
